(19) United States
(12) Patent Application Publication
(10) Pub. No.: US 2020/0302240 A1
(43) Pub. Date: Sep. 24, 2020

(54) LEARNING METHOD, LEARNING DEVICE, AND NON-TRANSITORY COMPUTER-READABLE STORAGE MEDIUM FOR STORING LEARNING PROGRAM

(71) Applicant: FUJITSU LIMITED, Kawasaki-shi (JP)

(72) Inventors: Miho Murata, Kawasaki (JP); Hironobu Kitajima, Kawasaki (JP); Tetsuyoshi Shiota, Yokohama (JP)

(73) Assignee: FUJITSU LIMITED, Kawasaki-shi (JP)

(21) Appl. No.: 16/817,872

(22) Filed: Mar. 13, 2020

(30) Foreign Application Priority Data
Mar. 19, 2019 (JP) 2019-051244

(51) Int. Cl. G06K 9/62; G06N 3/08

(52) U.S. Cl. CPC G06K 9/6262; G06K 9/6256; G06N 3/084

(57) ABSTRACT

A machine learning device includes: a model generator configured to generate a machine learning model by using first training data that includes image data, the image data including a target to be recognized and a label indicating the target to be recognized; a teaching data generator configured to generate second training data indicating a changed variation in characteristics related to the target to be recognized, based on recognition degrees at which the target to be recognized is recognized from verification data items when the image data is input as the verification data items to the generated machine learning model; and a learning executor configured to execute machine learning by inputting the generated second training data to the generated machine learning, model.

### CROSS-REFERENCE TO RELATED APPLICATION

This application is based upon and claims the benefit of priority of the prior Japanese Patent Application No. 2019-51244, filed on Mar. 19, 2019, the entire contents of which are incorporated herein by reference.

### FIELD

The embodiments discussed herein are related to a learning method, a learning device, and a non-transitory computer-readable storage medium for storing a learning program.

### BACKGROUND

Various information has been classified using a machine learning model, such as a neural network subjected to machine learning using teaching data. Although a large amount of teaching data is used in machine learning, such as deep learning (DL), it is difficult to prepare a large amount of teaching data in fact. An existing technique for converting the original teaching data to increase the amount of the data is known.

Examples of the related art are International Publication Pamphlet No. WO 2016/125500, International Publication Pamphlet No. WO 2007/105409, and Japanese Laid-open Patent Publication No. 5-324876.

### SUMMARY

According to an aspect of the embodiments, a machine learning device includes: a model generator configured to generate a machine learning model by using first training data that includes image data, the image data including a target to be recognized and a label indicating the target to be recognized; a teaching data generator configured to generate second training data indicating a changed variation in characteristics related to the target to be recognized, based on recognition degrees at which the target to be recognized is recognized from verification data items when the image data is input as the verification data items to the generated machine learning model; and a learning executor configured to execute machine learning by inputting the generated second training data to the generated machine learning model.

The object and advantages of the invention will be realized and attained by means of the elements and combinations particularly pointed out n the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of a learning device according to an embodiment;

FIG. 2 illustrates an operation example of the learning device according to the embodiment;

FIG. 3 is a flowchart illustrating the operation example of the learning device according to the embodiment;

FIG. 4 is a flowchart illustrating an operation example of the learning device according to the embodiment;

FIG. 5 describes how time indicated by a variable is divided; and

FIG. 6 illustrates an example of a computer that executes a learning program.

### DESCRIPTION OF EMBODIMENT(S)

In the foregoing existing technique, however, teaching data is uniformly generated from the original teaching data, and thus learning using the generated teaching data may not be efficiently progressed. For example, in the case where teaching data of a certain type with which a machine learning model hardly recognizes target data, and teaching data of another type with which the machine learning model easily recognizes the target data are uniformly generated, when data that is hardly recognized is learned, the learning may not be progressed as expected.

According to an aspect, provided are a learning method, a learning program, and a learning device that may improve a learning efficiency. Herein, the learning method, the learning program, and the learning device may be referred to as “machine learning method”, “machine learning program” and “machine learning device”, respectively.

According to the aspect, the learning efficiency of machine learning may be improved.

Hereinafter, a learning method, learning program, and learning device according to embodiments are described. In the embodiments, components having the same function are denoted by the same reference sign, and a redundant description thereof is omitted. The learning method, learning program, and learning device described in the following embodiments are merely examples and are not intended to limit the embodiments. In addition, the following embodiments may be combined as appropriate without inconsistency.

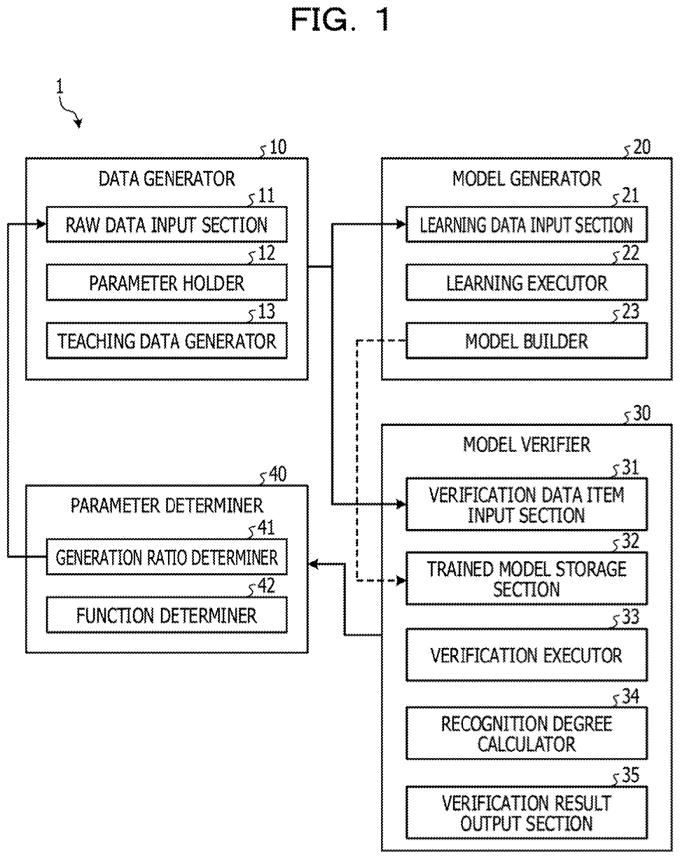

FIG. 1 illustrates an example of a functional configuration of a machine learning device according to an embodiment. A machine learning device 1 (may be referred to as “a learning device”) illustrated in FIG. 1 is an information processing device configured to train a machine learning model (may be referred to as “a learning model”). The machine learning model uses image data as learning data to classify (recognize) various information via a neural network or the like. The image data, which may be referred to as “graphic data”, “shape data”, and the like, is configured to include a target to be recognized and is configured to have, added thereto, a correct label indicating the target to be recognized. The target to be recognized indicates a person, a vehicle, or the like. For example, a computer, such as a personal computer (PC), is applicable as the learning device 1.

As illustrated in FIG. 1, the learning device 1 includes a data generator 10, a model generator 20, a model verifier 30, and a parameter determiner 40.

The data generator 10 is a processing section configured to generate teaching data, which may include learning data (may be referred to as “first training data”) to be used in a learning phase of generating the machine learning model. The teaching data may include verification data items to be used in a verification phase of verifying the trained machine learning model. For example, the data generator 10 includes a raw data input section 11, a parameter holder 12, and a teaching data generator 13.

The raw data input section 11 receives input of teaching data (raw data) prepared by a user in advance. In supervised learning, teaching data in which the correct label indicating the target to be recognized has been added, to the raw image data including the target to be recognized is prepared by the user in advance, wherein the raw image data may be referred to as the raw graphic data, the raw shape data, the raw data, and the like. The target to be recognized indicates a person, a vehicle, or the like. The raw data input section 11 receives input of the teaching data prepared by the user in advance from, for example, an external information processing device.

The teaching data prepared by the user in advance is referred to as raw data in some cases in order to distinguish the teaching data prepared by the user in advance from teaching data newly generated by data extension. The teaching data newly generated by the data extension is referred to as extended teaching data in some cases.

The parameter holder 12 holds a parameter to be used to newly generate the teaching data (extended teaching data) based on the raw data in the data extension. For example, the parameter holder 12 holds, in an internal memory or the like, the various parameters determined by the parameter determiner 40.

The teaching data generator 13 interpolates the original teaching data (raw data) based on the parameters held in the parameter holder 12 to generate intermediate data (image data) and executes the data extension on the intermediate data to generate the new teaching data (may be referred to as “extended teaching data”, “second training data”). For example, the teaching data generator 13 references a parameter (described later in detail) determined to interpolate verification data items for which recognition degrees are high and low or different from each other, based on recognition degrees calculated for the verification data items, and generates the intermediate data between the corresponding verification data items included in the teaching data (raw data).

In a method of executing the interpolation in the data extension, a morphing technique to be used to automatically generate an animated image and as-rigid-as-possible (ARAP) shape interpolation for shaping a distortion to maintain the geometry of an object may be used. The teaching data generator 13 uses the foregoing interpolation method to generate the teaching data (extended teaching data) indicating a changed variation in characteristics related to the, target included in the original teaching data (raw data) and to be recognized.

When the machine learning model is to be generated from the teaching data (raw data) prepared by the user in advance, the teaching data generator 13 divides the raw data into learning data and verification data items at a predetermined ratio, outputs the learning data to the model generator 20, and outputs the verification data items to the model verifier 30. When the machine learning model is to be rebuilt based on the extended teaching data, the teaching data generator 13 divides teaching data including the extended teaching data into learning data and verification data items at a predetermined ratio, outputs the learning data to the model generator 20, and outputs the verification data items to the model verifier 30. In this case, the teaching data generator 13 divides the teaching data so that the learning data and the verification data items do not overlap each other (for example, the ratio of the learning data and the verification data items is 8:2).

The model generator 20 is a processing section that generates the machine learning model using the learning data generated by the data generator 10. For example, the model generator 20 includes a learning data input section 21, a learning executor 22, and a model builder 23.

The learning data input section 21 receives input of the learning data generated by the data generator 10. The learning executor 22 uses the input learning data to train the machine learning model for recognizing a target included in image data using the neural network or the like.

As the machine learning model, a neural network in which units imitating brain neurons are hierarchically coupled to each other in layers from an input layer via intermediate layers to an output layer is applicable.

The learning executor 22 inputs the learning data to an input layer of the machine learning model and causes the machine learning model to output an output value indicating a calculation result from an output layer of the machine learning model. Then, the learning executor 22 learns parameters of nodes of the neural network of the machine learning model based on the comparison of a correct label added to the learning data with the output value. For example, the learning executor 22 learns the parameters of the neural network via error back propagation (BP) using the result of the comparison of the correct label with the output value or the like.

The model builder 23 builds the original machine learning model based on a hyperparameter indicating the configuration of the neural network or the like. The learning executor 22 uses the learning data to vain the machine learning model built by the model builder 23. The model builder 23 causes the parameters of the nodes of the machine learning model trained by the learning executor 22 to be stored in a trained model storage section 32.

The odd verifier 30 is a processing section that uses the verification data items generated by the data generator 10 to verify the machine learning model generated by the model generator 20. For example, the model verifier 30 includes a verification data item input section 31, the trained model storage section 32, a verification executor 33, a recognition degree calculator 34, and a verification result output section 35.

The verification data item input section 31 receives the input verification data items from the data generator 10. The trained model storage section 32 stores information (for example, the parameters of the nodes of the neural network) on the trained machine learning model verified by the model verifier 30.

The verification executor 33 uses the input verification data items to verify the trained machine learning model stored in the trained model storage section 32. The verification executor 33 reads, for example, information on the trained machine learning model from the trained model storage section 32 and builds the machine learning model. Subsequently, the verification executor 33 inputs the verification data items to the input layer of the built machine learning model and causes the machine learning model to output an output value indicating a calculation result from the output layer. Then, the verification executor 33 compares a correct label added to the verification data items with the output value.

The recognition degree calculator 34 calculates recognition degrees at which the target to be recognized is recognized from the verification data items, based on the verification executed by the verification executor 33 on the verification data items. For example, the recognition degree calculator 34 calculates the recognition degrees in data classification executed in image recognition on the image data and calculates recognition degrees in the detection of a specific portion within the image data as follows.

In the data classification executed in the image recognition, for example, an image of a product captured by a camera may be learned by the machine learning model, and whether the product is good or defective may be recognized as the target to be recognized. In this case, the recognition degree calculator 34 calculates an error (for example, cross entropy error) from a value of an output function (for example, softmax function or the like) of the neural network in the classification of a certain image (verification data items) into an good product or a defective product and calculates recognition degrees at which the target (good or defective) to be recognized is recognized from the verification data items.

As an example, it is assumed that a value of an output function when an image (t=[1, 0]) of a good product is classified is y=[0.8, 0.1] (the probability with which the product belongs to good products is 0.8, and the probability with which the product belongs to defective products is 0.1). In this case, a recognition degree=(1−E)*100 ={1+(1*ln 0.8+0*ln 0.1)}*100=77.69%. “E” is the cross entropy error—Σⁿₖ₌₁t^{k}ln y^{k} (“ln” is a natural logarithm of a base e). “y^{k}” is a value of a k-th output function, “t^{k}” is a value of a k-th verification data item, and “k” is the number (2 in this example) of classifications.

In the detection of the specific portion, an image of an object may be learned by the machine learning model, and a person or the like within the image may be identified, for example. In this case, the recognition degree calculator 34 calculates a recognition degree from a value of a loss function (weighted sum of a certainty error and a positioning error) used for an object detection algorithm, such as Single Shot MultiBox Detector (SSD). For example, the recognition degree={1−(L(x, c, l, g))}*100. In this case, x and c are certainty of a class, l is an estimated position, and g is a correct position. The value of the loss function, the certainty error, and the positioning error are expressed according to the following Equation (1).

$$\begin{matrix}\begin{matrix}The value of the loss function \text{:} L ( x , c , l , g ) = \\ \frac{1}{N} ( {L}_{conf} ( x , c ) + {aL}_{loc} ( x , l , g ) )\end{matrix} \\ \begin{matrix}The certainty error \text{:} {L}_{conf} ( x , c ) = * {\sum }_{i ∈ Pos}^{N} {x}_{ij}^{p} log ( {\hat{c}}_{i}^{p} ) * \\ {\sum }_{i ∈ Neg} log ( {\hat{c}}_{i}^{0} ) where {\hat{c}}_{i}^{p} = \frac{exp ( {c}_{i}^{p} )}{{\sum }_{p} exp ( {c}_{i}^{p} )} \\ The positioning error \text{:} {L}_{loc} ( x , l , g ) = {\sum }_{i ∈ Pos}^{N} {\sum }_{m ∈ \{ cx , cy , w , h \}} \\ {x}_{ij}^{k} {smooth}_{L 1} ( {l}_{i}^{m} - {\hat{g}}_{j}^{m} ) \\ {\hat{g}}_{j}^{cx} = ( {g}_{j}^{cx} - {d}_{i}^{cx} ) / {d}_{i}^{w} {\hat{g}}_{j}^{cy} = ( {g}_{j}^{cy} - {d}_{i}^{cy} ) / {d}_{i}^{h} \\ {\hat{g}}_{j}^{w} = log ( \frac{{g}_{j}^{ww}}{{d}_{i}^{w}} ) {\hat{g}}_{j}^{h} = log ( \frac{{g}_{j}^{h}}{{d}_{i}^{h}} )\end{matrix}\end{matrix} \} \qquad ( 1 )$$

The verification result output section 5 outputs, as verification results, the recognition degrees calculated by the recognition degree calculator 34 for the verification data items to the parameter determiner 40.

The parameter determiner 40 is a processing section that determines a parameter to be used in the generation of new teaching data by the teaching data generator 13 in the data extension. For example, the parameter determiner 40 includes a generation ratio determiner 41 and a function determiner 42.

The generation ratio determiner 41 determines, based on the recognition degrees calculated for the verification data items, a generation ratio of an intermediate image or graphic in the interpolation of the original teaching data (raw data). The function determiner 42 determines, based on the recognition degrees calculated for the verification data items, a function to be used for the interpolation of the original teaching data (raw data).

For example, a recognition degree calculated for a verification data item may be high or low in the trained machine learning model, depending on how the target to be recognized has been imaged. Thus, in the data extension, to progress the learning of a target that is to be recognized and for which a recognition degree has been determined to be low in the verification, verification data items that are included in the teaching data (raw data) and for which recognition degrees are different are interpolated to generate new teaching data.

Thus, the function determiner 42 calculates a pair of verification data items for which recognition degrees are high and low or different from each other, based on the recognition degrees calculated for the verification data items. Then, the function determiner 42 uses a method, such as regression analysis, to calculate a function of interpolating the calculated pair of verification data items. For example, in the ARAP shape interpolation, a function of generating an intermediate graphic of two graphics using time as a variable is determined. The function determiner 42 treats the function determined in the foregoing manner as a function (of interpolating data) of defining a relationship between the verification data items for which the recognition degrees are high and low or different from each other.

The function determiner 42 outputs, as a single parameter, the function obtained for the pair of verification data items to the teaching data generator 13. The teaching data generator 13 may continuously change the time indicated by a variable of the function, thereby generating an intermediate image or graphic by smoothly interpolating the two graphics (pair of verification data items).

The generation ratio determiner 41 determines divided time intervals for the variable of the function as a generation ratio of the intermediate image or graphic based on the recognition degrees calculated for the pair of verification data items, which are generation sources of the intermediate image or graphic. For example, the generation ratio determiner 41 divides the time indicated by the variable of the function into short time intervals for low recognition degrees and long time intervals for high recognition degrees, without equally dividing the time indicated by the variable of the function.

Regarding the pair of verification data items, a time interval into which the time is divided may increase from a divided time interval for the lower recognition degree to a divided time interval for the higher recognition degree according to a linear function, an exponential function, or a sigmoid function. In the case where the time interval into which the time is divided increases according to any of the functions (linear function, exponential function, and sigmoid function), a parameter that determines an inclination of the function or determines how a value of the function rises is determined based on the difference between the recognition degrees calculated for the pair of the verification data items.

As an example, the case where the time interval into which the time is divided increases according to the exponential function is described below. First, the generation ratio determiner 41 calculates the difference between the recognition degrees calculated for the pairs of verification data items that are the generation sources of the intermediate image or graphic. Then, the generation ratio determiner 41 determines the parameter that determines the inclination of the function or determines how the value of the function rises, based on the calculated difference between the recognition degrees. For example, when the difference between the maximum and minimum values of the recognition degrees calculated for the verification data items is larger than a predetermined threshold, the generation ratio determiner 41 sets an exponent (a) of an exponential function (y=a^{x}) to a large value (so that the value of the exponential function rapidly increases) to increase a generation ratio for the lower recognition degree.

The generation ratio determiner 41 outputs, as a single parameter, the divided time intervals (or the inclination of the function or the rise of the function that is related to the increase in the divided time interval) for the variable of the function obtained for the pair of verification data items to the teaching data generator 13. The teaching data generator 13 may change the time indicated by the variable of the function based on the divided time intervals, thereby changing the generation ratio of the intermediate image or graphic to be generated by smoothly interpolating the two graphics (pair of verification data items). For example, when the divided time interval for the lower recognition degree is set to a short time interval and the divided time interval for the higher recognition degree is set to a long time interval, a large number of intermediate images or intermediate graphics that are similar to a graphic shape with a low recognition degree are generated.

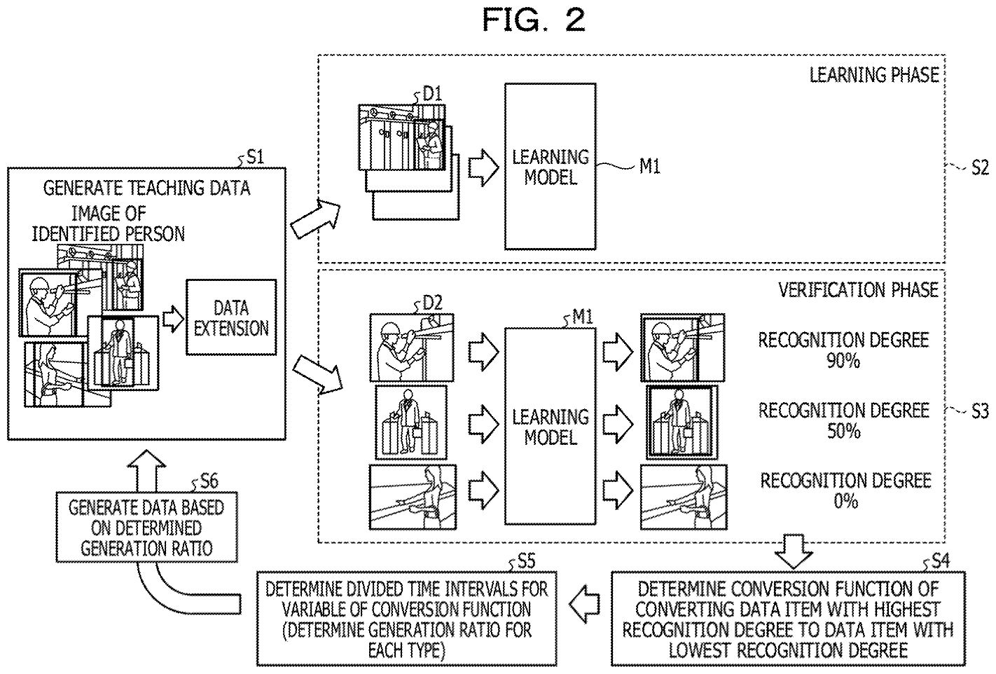

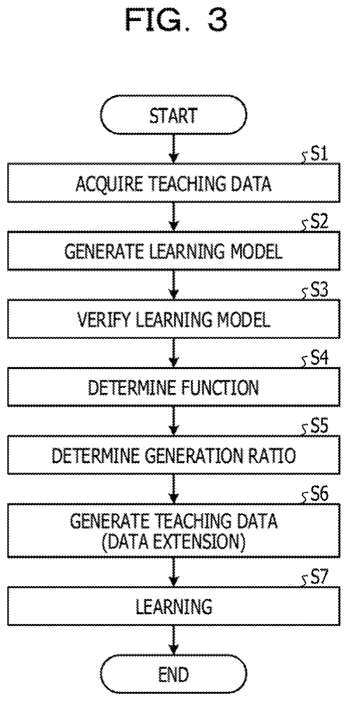

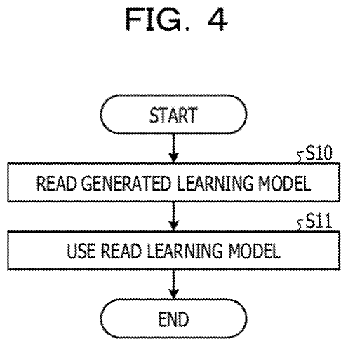

Next, operations of the learning device 1 are described in detail. FIG. 2 illustrates an operation example of the learning device 1 according to the embodiment. FIGS. 3 and 4 are flowcharts of operation examples of the learning device 1 according to the embodiment.

As illustrated in FIGS. 2 and 3, the data generator 10 acquires the teaching data (raw data) prepared by the user in advance (in S1) and generates learning data D1 and verification data items D2 based on the acquired teaching data.

Then, the model generator 20 uses the learning data D1 to execute a learning phase of generating a machine learning model M1 (in S2). Then, the model verifier 30 uses the verification data items D2 to execute a verification phase of verifying the machine learning model M1 generated by the model generator 20 (in S3). Thus, the learning device 1 obtains recognition degrees for the verification data items D2 in the machine learning model M1.

Then, the function determiner 42 determines a function to be used to interpolate the original verification data items D2 based on the recognition degrees for the verification data items D2 (in S4). For example, the function determiner 42 determines a conversion function of converting a verification data item D2 with the highest recognition degree to a verification data item D2 with the lowest recognition degree based on the recognition degrees for the verification data items D2.

Then, the generation ratio determiner 41 determines a generation ratio of an intermediate image or graphic or divided time intervals for a variable of the conversion function based on the recognition degrees for the pair of verification data items that are generation sources of the intermediate image or graphic (in S5).

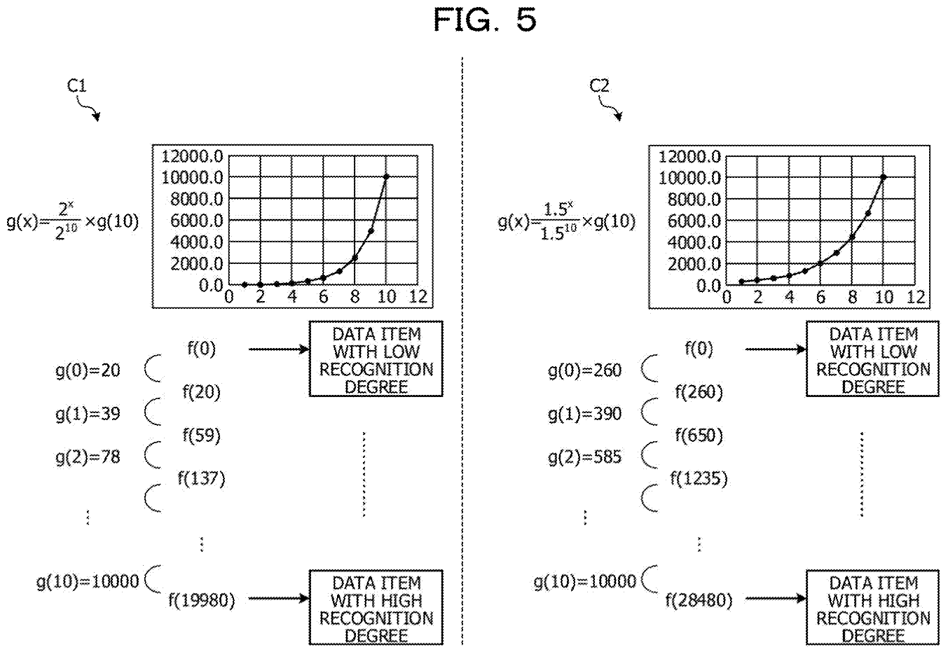

FIG. 5 illustrates how time indicated by the variable is divided. In FIG. 5, f(t) is a function (function of generating an intermediate graphic in the ARAP shape interpolation or the like) of defining a relationship between a verification data item D2 with a higher recognition degree and a verification data item D2 with a lower recognition degree. g(x)=(a^{x}/aⁿ)*g(n) is a function of determining time intervals into which time (t) indicated by a variable of the function f(t) is divided (n is the number of data items to be generated).

As illustrated in FIG. 5, in case C1 where the difference between the highest and lowest values among the recognition degrees for the verification data items D2 is large, an exponent (a) is set to a relatively large value (a=2) so that the value of the function rapidly increases. On the other hand, in case C2 where the difference between the highest and lowest values among the recognition degrees for the verification data items D2 is small, the exponent (a) is set to a relatively small value (a=1.5) so that the value of the function gradually increases. Thus, a divided time interval for the lower recognition degree in case C1 is shorter than that in case C2, and the number of intermediate images or intermediate graphics that are generated and similar to the graphic shape with the low recognition degree in case C1 is larger than that in case C2.

Subsequently, the teaching data generator 13 generates new teaching data by executing the data extension to interpolate the pair of verification data items as the sources and generate intermediate data, based on the function determined in S4 and the generation ratio (divided time intervals for the variable) determined in S5 (in S6). Subsequently, the model generator 20 uses the extended teaching data generated by the data extension to train (retrain) the machine learning model M1 (in S7) and terminates the process.

The learning device 1 may repeatedly execute the foregoing processes of S3 to S7 until a predetermined requirement is satisfied. For example, the learning device 1 may repeatedly execute the processes of S3 to S7 a predetermined number of times or repeatedly execute the processes of S3 to S7 until the difference between the recognition degrees for the verification data items D2 becomes equal to or lower than a predetermined value. Thus, by repeatedly executing the processes of S3 to S7, the learning device 1 may progress the learning of the machine learning model M1 while executing the data extension to change the type of data to be generated and learned in a prioritized manner.

The model verifier 30 may execute an application phase of applying the generated machine learning model M1 to image data to be recognized and obtaining a result of the recognition. For example, as illustrated in FIG. 4, when the application phase is started, the model verifier 30 reads the machine learning model M1 generated in the series of processes illustrated in FIG. 3 from the trained model storage section 32 (in S10).

Subsequently, the model verifier 30 uses the read machine learning model M1 to obtain a result of recognizing the image data to be recognized (in S11). For example, the model verifier 30 inputs the image data to be recognized to an input layer of the read machine learning model M1 and obtains an output value indicating the recognition result from an output layer of the machine learning model M1.

As described above, the learning device 1 includes the model generator 20, the teaching data generator 13, and the learning executor 22. The teaching data generator 13 generates the machine learning model M1 that has learned, as learning data, the image data that includes the target to be recognized and has, added thereto, a label indicating the target to be recognized. The teaching data generator 13 generates teaching data indicating a changed variation in characteristics related to the target to be recognized, based on the recognition degrees at which the target to be recognized is recognized from the verification data items when the image data is input as the verification data items to the generated machine learning model M1. For example, the teaching data generator 13 interpolates verification data items for which recognition degrees are high and low or different from each other, thereby generating the teaching data indicating the changed variation in characteristics related to the target to be recognized. The learning executor 22 causes the machine learning model M1 to execute relearning using the generated teaching data. The learning device 1 may improve the learning efficiency by causing the machine learning model M1 to execute the relearning on a target, although it is difficult to recognize the target using teaching data indicating a changed variation in characteristics related to the target to be recognized.

The teaching data generator 13 changes, based on a parameter determined by the parameter determiner 40, divided time intervals for which a variable is changed in the case where teaching data is generated while the variable of a function to be used to interpolate verification data items for which recognition degrees are high and low or different from each other is changed. For example, the teaching data generator 13 sets divided time intervals so that a divided time interval for which the variable is changed for a higher recognition degree is longer than a divided time interval for which the variable is changed for a lower recognition degree. Since a large number of teaching data items, which indicate shapes similar to a target that is to be recognized and for which a recognition degree is low, are generated, and the machine learning model M1 executes the relearning, the learning of data that is hardly recognized may be efficiently progressed.

Although the embodiment exemplifies the error back propagation as the learning method of the neural network in the machine learning model, known various methods other than the error back propagation may be used. The neural network is composed of multiple stages, for example, the input layer, the intermediate layers (hidden layers), and the output layer and has a structure in which multiple nodes of each of the layers are coupled to multiple nodes of one or more other layers among the layers via edges. Each of the layers has a function that is referred to as “activation function”. Each of the edges has a “weight”. A value of each of nodes of each of the layers is calculated from values of nodes of a previous layer, values of weights of edges coupled to the layer, and an activation function of the layer. As a method for the calculation, known various methods may be used. As the machine learning, various methods, such as support vector machine (SVM), other than the neural network may be used.

The constituent components of the sections illustrated may not be physically configured as illustrated in the drawings. For example, specific forms of the distribution and integration of the sections may not be limited to those illustrated in the drawings, all or some of the sections may be functionally or physically distributed or integrated in arbitrary units based on various loads and usage statuses. For example, the data generator 10 and the parameter determiner 40 may be integrated with each other, or the model generator 20 and the model verifier 30 may be integrated with each other. The processes illustrated in the drawings may not be executed in the foregoing order. Two or more of the processes may be simultaneously executed without contradicting the details of the processes. The order in which the processes are executed may be changed without contradicting the details of the processes.

All or some of the various processing functions to be executed by the devices may be executed on a CPU (or a microcomputer, such as a microprocessor unit (MPU) or a micro controller unit (MCU)). All or some of the various processing functions may be executed on a program analyzed and executed by the CPU (or the microcomputer, such as the MPU or the MCU) or may be executed on hardware using wired logic.

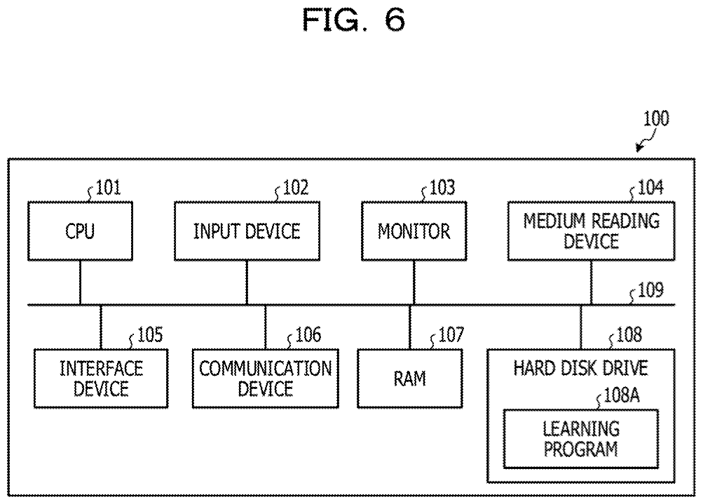

The various processes described above in the embodiments may be enabled by causing a computer to execute a program prepared in advance. An example of a computer that executes a learning program having the same functions as those described in the embodiments is described below. FIG. 6 illustrates an example of the computer that executes the learning program.

As illustrated in FIG. 6, a computer 100 includes a CPU 101 for executing various arithmetic processing, an input device 102 for receiving data input, and a monitor 103. The computer 100 includes a medium reading device 104 for reading the program and the like from a recording medium, an interface device 105 to be coupled to various devices, and a communication device 106 for coupling the computer 100 to another information processing device via a cable or wirelessly. The computer 100 also includes a RAM 107 for temporarily storing various information, and a hard disk drive 108. The devices 101 to 108 are coupled to a bus 109.

In the hard disk drive 108, a learning program 108A is stored. The learning program 108A has the same functions as the processing sections, the data generator 10, the model generator 20, the model verifier 30, and the parameter determiner 40, which are illustrated in FIG. 1. In the hard disk drive 108, various data, which is used to enable the data generator 10, the model generator 20, the model verifier 30, and the parameter determiner 40, is stored. The input device 102 receives input of various information, such as operation information, from a user of the computer 100, for example. The monitor 103 displays various screens, such as a display screen, for the user of the computer 100. The interface device 105 is coupled to, for example, a printing device or the like. The communication device 106 is coupled to a network not illustrated and transmits and receives various information to and from the other information processing device.

The CPU 101 executes various processes by reading the learning program 108A stored in the hard disk drive 108, loading the learning program 108A into the RAM 107, and executing the learning program 108A. The learning program 108A causes the computer 100 to function as the data generator 10, the model generator 20, the model verifier 30, and the parameter determiner 40, which are illustrated in FIG. 1.

The foregoing learning program 108A may not be stored in the hard disk drive 108. For example, the computer 100 may read and execute the learning program 108A stored in a recording medium readable by the computer 100. The recording medium readable by the computer 100 corresponds to, for example, a portable recording medium, such as a compact disc read-only memory (CD-ROM), a digital versatile disc (DVD), or a Universal Serial Bus (USB) memory, a semiconductor memory, such as a flash memory, or a hard disk drive. The learning program 108A may be stored in a device coupled to, for example, a public network, the Internet, or a local area network (LAN) and may be read and executed by the computer 100 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A machine learning method implemented by a computer, the machine learning method comprising:
generating a machine learning model by using first training data that includes image data, the image data including a target to be recognized and a label indicating the target to be recognized;
generating second training data indicating a changed variation in characteristics related to the target to be recognized, based on recognition degrees at which the target to be recognized is recognized from verification data items when the image data is input as the verification data items to the generated machine learning model; and
executing machine learning by inputting the generated second training data to the generated machine learning model.

2. The machine learning method according to claim 1, wherein
the generating of the second training data is configured to interpolate verification data items for which recognition degrees are different from each other.

3. The machine learning method according to claim 2, wherein
the generating of the second training data is configured to adjust divided time intervals so that a divided time interval for which a variable is changed for a higher recognition degree is longer than a divided time interval for which the variable is changed for a lower recognition degree, in the case where the second training data is generated while the variable of a function to be used to interpolate the verification data items for which the recognition degrees are different from each other is changed.

4. The machine learning method according to claim 1, wherein
the generating of the second training data is configured to use, as the verification data items, data items that are included in the image data and are not used as the first training data.

5. A non-transitory computer-readable storage medium storing a machine learning program that causes a computer to execute a process, the process comprising:
generating a machine learning model by using first training data that includes image data, the image data including a target to be recognized and a label indicating the target to be recognized;
generating second training data indicating a changed variation in characteristics related to the target to be recognized, based on recognition degrees at which the target to be recognized is recognized from verification data items when the image data is input as the verification data items to the generated machine learning model; and
executing machine learning by inputting the generated second training data to the generated machine learning model.

6. A machine learning device comprising:
a model generator configured to generate a machine learning model by using first training data that includes image data, the image data including a target to be recognized and a label indicating the target to be recognized;
a teaching data generator configured to generate second training data indicating a changed variation in characteristics related to the target to be recognized, based on recognition degrees at which the target to be recognized is recognized from verification data items when the image data is input as the verification data items to the generated machine learning model; and
a learning executor configured to execute machine learning by inputting the generated second training data to the generated machine learning model.
